(19) United States
(12) Patent Application Publication
(10) Pub. No.: US 2002/0131580 A1
(43) Pub. Date: Sep. 19, 2002

(54) Solid angle cross-talk cancellation for beamforming arrays

(75) Inventor: Steven Shawn Smith, Evanston, IL (US)

Correspondence Address: BANNER & WITCOFF, 1001 G STREET N W, SUITE 1100, WASHINGTON, DC, 20001, US

(73) Assignee: Shure Incorporated, Evanston, IL

(21) Appl. No.: 10/085,172

(22) Filed: Feb. 27, 2002

Related U.S. Application Data
(60) Provisional application No. 60/276,371, filed on Mar. 16, 2001.

(51) Int. Cl. H04R 3/00; H04M 1/00; H04M 1/76

(52) U.S. Cl. 379/387.01; 379/417; 381/122

(57) ABSTRACT

A non-adaptive system and method for improving on-axis pickup of a signal by a transducer, such as a microphone, where the signal received by the transducer is can be spatially represented as lobes or beams, the on-axis pickup being improved by removing the side portions of the beams. The input signal, or signals, has a predetermined location, whether that is at zero degrees on a polar plot or elsewhere, and the system produces an output beamwidth as narrow as possible. The input beams of the signal (or signals) received are processed to produce cancellation beams, and the cancellation beams are then steered, using phase or time delays, to overlap with the desired input beams outside of the desired output beamwidth. Via superpositioning, the cancellation beams are then subtracted from the desired input beams resulting in an output beam with a narrower beamwidth, and thus improving on-axis pickup by automatically excluding portions of the beam considered likely to be interfering sources or generally undesirable signal.

### CROSS-REFERENCE TO RELATED APPLICATIONS

This application claims priority to U.S. Provisional Application Serial No. 60/276,371, filed, Mar. 16, 2001, to Steven Shawn Smith of Evanston, Ill.

### BACKGROUND OF THE INVENTION

This invention relates to microphones, in particular, interference cancellation of a signal received by a microphone, and, more particularly, to techniques for canceling the solid angle cross-talk of a signal and narrowing the width of a beampattern by subtracting off signals coming from a region of space shared by said beampattern and single or multiple overlapping beampattern(s).

In acoustic (audio) signal processing, a signal can be subtracted from another signal by combining the two signals, also known as superpositioning. More precisely, cancellation of any signal may be achieved via linear superposition of an inverted exact duplicate of the signal with itself, or with a second signal which is highly correlated with the exact inverse of said signal. For example, a signal is typically a sinusoidal wave with a peak and a trough representing a positive and negative displacement, respectively, from a mean of the signal wave. When said second signal is combined with the first signal, the displacement of the two signals is summed at each point along the intersection of the two signals or waves. When a positive displacement is summed with a negative displacement at a particular point, the resulting combined wave at that point is the difference in the two displacements. When two positive displacements are summed, the resulting combined wave at that point is the sum of the displacements.

A transducer converts an acoustic signal to an analog electrical signal. Though referred to simply as “signals” for convenience, acoustic signals are specifically continuous voltage (analog) conversions of atmospheric compression and expansion about static mean pressure via physical coupling of the transducer to the medium. For acoustic applications said transducer is a microphone, hydrophone, geophone, or similar device. Digital signals are the conversion of said analog signals to numerical data by an analog-to-digital converter (ADC).

U.S. Pat. No. 6,049,607, to Marash, et al., ('607) is incorporated herein by reference. The '607 reference describes a system used to cancel a signal, particularly an echo or multipath. In one embodiment, '607 uses a linear or arbitrary distribution of receivers. In this embodiment, '607 cancels an echo by recognizing a signal received by a plurality of microphones with time delay steering, for example, and comparing that signal to a second channel carrying an incoming signal. The system thus recognizes the signal at the second microphone to be far-field echo, and subtracts the signal from the total signal received by the plurality of microphones via superpositioning. The method of superpositioning is implemented via selection of one or more input beamformers, and bandlimited adaptive filters. Such a system is continuously adaptive.

More specifically, '607 uses continuously adaptive digital signal processing (DSP) on a number of steered beams to subtract signal from a person on the other end of a transmission line from the voice of the talker (target signal) received by an array in the transmission room. It does this by running a number of bandlimited adaptive filters on a plurality of beams, and subtracting the output signals from the “target” signal. This can result in a “pumping” of background noise as the filters continuously “look” for signals to cancel (i.e. continuously adapt)—as long as threshold conditions are met. “Pumping,” as used herein, refers to a situation where the output is not constant, and, accordingly, the background output is changing. This allows crossover leak from multiple signals, echoes, as well as rapid changes in signal characteristics. In the following discussion the term “noise” refers to any signal that is not considered to be desirable output.

The filtering in '607, simply stated, is performed by splitting the signals from multiple beams into the bandlimited frequency domains and not passing those bandlimited signals that are considered undesirable. The '607 process is adaptive according to signal received and continually must re-calculate the steering based on the signals received. The '607 process splits the signal of multiple beams into bandlimited frequency domains and adaptively filters each domain before recombining each at the output. This causes the quality of the output signal to vary continuously.

The microphone system made by the Audio-Technica company and marketed under the name AT-895 incorporates the method of U.S. Pat. No. 5,825,898, to Marash, et al., ('898) and U.S. Pat. No. 6,084,973, to Green et. al., ('973), which are each incorporated by reference herein. The signal received by the group of microphones is split into multiple signals of fixed frequency bandwidth, and the multiple signals are analyzed for undesirable/interfering signals. The bandlimited beams are steered about the axis of a reference beam or microphone and subtracted from the reference beam or microphone. “Steering a beam,” as used herein, is a term used to describe rotating the beam around a reference point on a polar graphical representation of the signal. As used herein, the term “adaptive” refers to the fact that the system continually monitors the input signals and removes what are considered undesirable/interfering signals, continually adjusts the steering of the beams, and continually adjusts portions that are overlapped for subtraction via filtering. This is known in the field of the art as “null steering,” or, because it includes bandlimited adaptive filtering, “bandlimited null steering.”

The '898 and '973 references are based on principles originating in telecommunications applications, such as speech directed at a hands-free telephone, that have been applied to high-end audio systems. Accordingly, it is ideally suited and reasonably functions only for a narrow band of signal range (bandwidth). Therefore, over a broad band, '898 has problems, particularly with processing a full range of acoustic signals for high quality sound reception, processing, and amplification. Accordingly, the methods taught by the '898 and '973 references, and utilized by AT-895 microphone have a number of problems.

The methods of '898 and '973 are confused by additional and/or complex (variable state) signals. Signals arriving on the main axis are desirable, and signals arriving from off the main axis are considered undesirable. Bandlimited cancellation beams are steered to angles on a continually adaptive (frequency and time dependent basis). The methods can experience distinct problems analyzing reflections because the time delay for an echo may be great enough that the system may no longer view it as an echo but instead as a new signal. Multi-path acoustic signals can also cause problems for the signal processing. The direction of the steering will be constantly changing with respect to frequency as multiple beams are steered in multiple directions. As the system must isolate and maintain ever changing cancellation or “null steering” beams, beams may disappear and reappear based upon the changing of the audio source, the processing possible by a microphone system utilizing these methods is dependent on the number of simultaneous adaptive beams that the system hardware can support. The resulting directivity pattern of the microphone, as a function of frequency, is therefore not constant and is forever changing.

Additionally, the background noise can be pumped if not cancelled properly. Pumping, in simple terms, is the rapid variation of output signal caused by continually adaptive switching between pickup patterns directed at different solid angles and therefore containing various spectral content (differing frequency signatures) over time. If the superpositioned noise signal is not the inversion of or a high correlation to the undesired signal, such as simply being not properly aligned in time (phase) or another misapplication, the superpositioned signal increases the total combined uncorrelated signal (noise) instead of causing the undesired signal to tend toward zero amplitude (thereby reducing ratio of desired signal to noise). This is called pumping due to the rapid variation in the spectral content of the output signal based on the superposition of beamformers or nulls, which changes on a continually adaptive basis. Additionally, by implementing bandlimited null steering, the overall shape of the total pickup pattern of the transducer array as a whole will continuously change. This may result in highly inconsistent pick-up patterns across the set of frequency bands. Off-axis signals (noise, undesirable signals) pump up and down, causing rising and lowering levels of noises as the beampatterns and output spectra of their associated signals continually adapt. Simply stated, there are a number of problems known in the art that result from using a continuously adaptive signal processing method.

As a result of these problems with the methods and apparati disclosed by these U.S. Pat. Nos. 6,049,607 '607, 6,084,973, and 5,825,898, continuously adaptive microphone pickup algorithms are not appropriate for complex signals associated with high quality audio applications, especially in enclosed environments, because, for instance, they may present multiple signal paths to the transducer(s), such as sound reflections, resulting in continuously variable signal output.

Beamforming is known and practiced in various manners. It is possible, and most typical, to form beams in a system requiring multiple transducers or transducer elements. However, it is possible to utilize a single transducer, as is described in U.S. Pat. No. 5,862,240, to Ohkubo, et al. Okhubo is directed towards a system for utilizing multiple sound paths to a single microphone or transducer element, and its specification is incorporated herein by reference. Further, it is known in the art that multiple tubes in conjunction with insulation and varying lengths may be used to attenuate and phase shifted sound in multiple tubes for beamforming and steering purposes. In addition, other arrangements for forming beams are disclosed by U.S. Pat. No. 5,651,074 to Baumhauer, et al., and U.S. Pat. No. 5,848,172 to Allen, et al., the specifications of which are incorporated herein by reference.

### BRIEF SUMMARY OF THE INVENTION

The applicant has concluded through an improved understanding of spatial filtering and acoustic signal processing that a better method for improving on-axis pickup is simply to eliminate off-axis pickup by inverse superposition of properly scaled signals from one or more pickup patterns which share overlapping solid angles or regions of space with one or more main (desired) pickup patterns. Additionally, applicant has concluded that the method of the disclosed reference patents, or similar methods which result in continuous changes of the pickup pattern of the receiver(s), introduces detrimental additional random signals by continuously pumping varying lobes of an adaptive noise cancellation algorithm.

In accordance with one aspect of the present invention, generally stated, the method processes non-adaptive beams in a parallel manner. A microphone receives a combined signal recognizable in a polar plot as lobes or beams. The method processes beams to either side of desired, or main, lobes or beams. The method recognizes multiple lobes which overlap either in two dimensions or in three of a polar plot. A weighted cancellation beam is a signal derived directly from a beam steered to an angle by phase or time delays, causing an overlap between the cancellation beam and the desired beam(s). The superpositioning of these weighted cancellation beams with the desired beams results in the removal, or cancellation (more appropriately, reduction), of the edges of the profile of the desired beams or lobes. Further, in accordance with the present invention, a user of the system may have a particular direction from which a signal is expected. Accordingly, the desired beampattern can be steered in the desired direction, and the edges of the profile of the beam signal received from the desired direction can be removed in this manner, thereby attenuating the signal and removing undesired interference or background signal.

The present invention utilizes beamforming. Beamforming is known in the art in various manners and implementations. The present invention can utilize beamforming accomplished by digital, analog, or acoustic path-length delay beamforming.

### BRIEF DESCRIPTION OF THE DRAWINGS

In the drawings, FIG. 1 is a schematic view of the present invention;

FIG. 2 is a representational view of an idealized polar plot of a beam of the present invention with its central axis at zero degrees;

FIG. 3 is a representational view of an idealized polar plot of a beam of the present invention with its central axis steered from zero degrees by angle Θ;

FIG. 4 is a polar plot of the output of signals processed and unprocessed by the present invention;

FIG. 5 is a polar plot of various frequencies signals unprocessed by the present invention;

FIG. 6 is a polar plot of various frequencies signals processed by the present invention;

FIG. 7 is a polar plot of various frequencies signals unprocessed by the present invention;

FIG. 8 is a polar plot of various frequencies signals processed by the present invention; and

FIG. 9 is a flow chart representing the processing of the present invention.

### DETAILED DESCRIPTION OF THE PREFERRED EMBODIMENT

This invention uses additional, overlapping non-adaptive beams to narrow the beamwidth of an existing beamformer without attempting to cancel a specific interfering source or cancel signals strictly on a bandlimited basis. Beamforming refers to the process or reinforcement of an acoustic signal from a specific angle by the coherent superposition or “stacking” of a plurality of elemental signals which have been phase delayed or time delayed to time-align the acoustic emissions originating from that angle. Herein, “beampattern” refers to the magnitude of the sensitivity of one or more transducers to acoustic signals as a function of azimuthal angle. This is commonly referred to in the art as the directivity function.

In a particular direction of a recognizable lobe of a signal beam, the signal from the edges of the lobe, represented as left and right sections of the lobe in a polar plot, is considered to be interference because it comes from a segment of space that does not contain the source of interest. As an attempt to identify the edges of the lobes is not made, it is of no consequence whether the signal is periodic or aperiodic.

The invention isolates the off-axis signals and uses linear superpositioning. As used herein, cross-talk cancellation is used to denote the process of phase or delay steering a cancellation beam from a main beam such that a region of beampattern overlap exists, superpositioning the inverted and/or attenuated signal of the cancellation beam with the main beam, and producing a resulting desired narrower beamwidth for the main beam.

Referring now to the drawings, FIG. 1 represents a system 10 of the present invention which processes input signals I and produces output signal O. Inputs I may be multiple input signals received by a single transducer T, or microphone, or by a plurality of transducers T. As is known in the field of the art, a microphone is principally a transducer that converts an acoustic audio signal into an electrical audio signal. However, a single microphone can contain multiple transducers, as well as a single transducer can receive multiple acoustic signals that are separable as distinct. The input signals I are analog signals derived from acoustic sources (not shown) located away from the transducers T.

Once converted to analog electrical signals, the input signals I are converted from analog to digital data, represented by analog to digital converters 12. The A/D converter 12 sends the digital signals D to a Phase/Delay or beamformer 14. The signals D are then converted to a set of signals which are post-processed by post-processing blocks/filters 16 to produce output beamformer signals B₁, B₂ . . . B_{N}. The process of receiving acoustic signals (input signals) I by transducers T and converting these to digital signals D that have been filtered and summed is known in the field of the art. This process can be accomplished by a dedicated microprocessor, or by a microprocessor or computer machine performing computer executable instructions carried as software, or by any other means of processing these steps (i.e. analog circuitry).

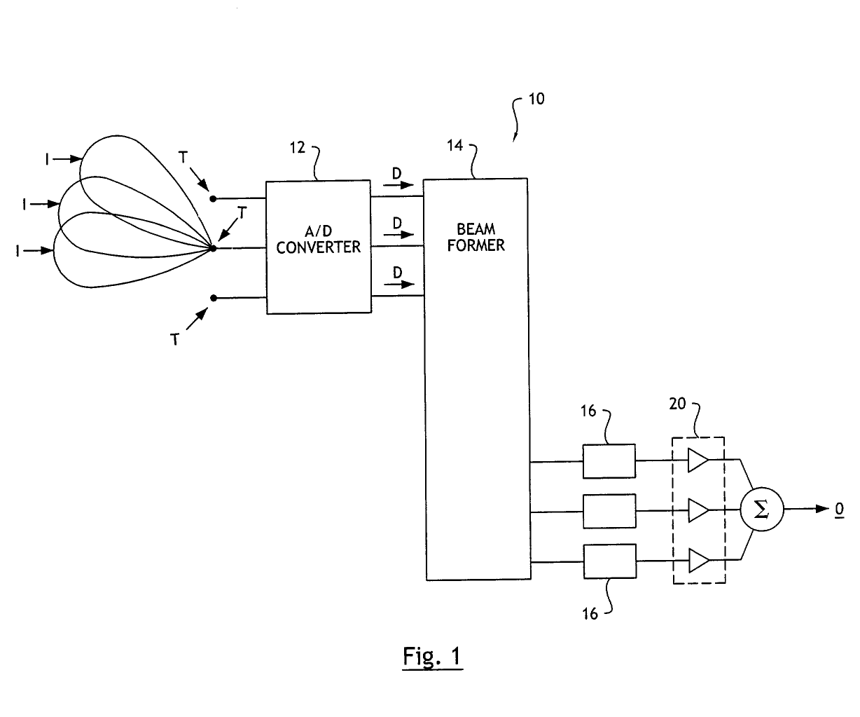

Next, cross-talk cancellation of the present invention is performed, represented by an algorithmic block 20. The block 20 includes amplifiers/weighting coefficients 22 and an algorithm 24. Means for the algorithm 24 may be analog electronics, may be a microprocessor, or a computer performing executable instructions, or any other means for performing these steps, as are known in the art. The coefficients 22 may be preprogrammed or carry on-board instructions, as well as are controlled by the algorithm 24. The processing that occurs in the system 10 incorporates a number N of output beams, represented as B₁, B₂ . . . B_{N}, collectively referred to as B_{N}. As each output beam B_{N} may provide a component of noise in a particular desired signal, it is provided that each output beam B_{N} may provide a portion of signal to be removed via superpositioning from the desired signal. In order to weight each portion of signal from each output beam B_{N}, an attenuation coefficient a_{N} is provided (typically on the order of 0.00 to 0.20, though not necessarily) for output beams 1 to N. The beams can be denoted as B_{X} for desired beams from 1 to X. The beam B_{X} follows the equation B_{X}=Σa_{N}B_{N}. This equation is a summation that occurs in block 20. This crosstalk cancellation results in the desired lobes or beams as signals, represented by M in FIG. 2, which are then summed to produce the output signal O. The output signal O follows the equation O=ΣB_{X}.

In FIG. 1, the method of beamforming may be any method of beamforming, including delay/sum, and frequency domain beamforming. The optimal practice of the invention results from beamforming that produces beams with predictable overlapping segments.

In FIG. 2, an idealized two-dimensional polar plot of signal received by N transducers is depicted. Along the horizontal axis of FIG. 2 are points representing multiple transducers T. As noted above, each transducer T may be a separate microphone, may be multiple transducers within a single microphone, or may be portions or elements of a transducer T that allows for identifying a distinct audio signal represented as a beam as in a polar representation, as shown in FIGS. 1-3. The transducers T may be of any number (even or odd), and such are represented in the quantity of N. In addition to noting the transducers T need not necessarily be a separate and discreet microphone but may also be a point on a microphone where the microphone is capable of perceiving audio (acoustic) signals at a discreet location, it should also be noted that this array of transducers T need not be linear in either spacing or overall shape.

The central lobe is the main beam M and is the desired beam. On either side of the main beam M are two cancellation beams C_{L}, C_{R}. In FIG. 2, the steering angle Θ of the main beam M is 0°, coinciding with the central axis of the main beam M. The central axes of the cancellation beams C_{L}, C_{R} are offset from the central axis of the main beam M by steering angles Φ_{L}, Φ_{R}, respectively, and Φ_{L} and Φ_{R} are referred to as the azimuths of the cancellation beams C_{L}, C_{R}. The main beam M and the cancellation beams C_{L}, C_{R} overlap resulting in shaded regions, R_{L} and R_{R}, and where the main beam M and the cancellation beams C_{L}, C_{R} share solid angles Ω_{L} and Ω_{R}.

The main beam M initially has a beamwidth β on a polar representation. The beamwidth β may or may not be known. The width of the main beam is generally known by either simulation or measurement. The widths of the cancellation beams may be determined by simulation or experiment. The resulting beamwidth is a function of the angle and amplitude coefficient of the cancellation beams—and therefore the amount of overlap. This may or may not be determined in advance by simulation or measurement. This may be determined by empirical measurement of the directivity pattern of the system. The beamwidth β is assumed to contain a desired signal accompanied by undesirable noise along its edges (here, all unwanted signals are considered noise). It is further assumed that the elimination of undesirable/interfering signals produces the resulting beam with a beamwidth β′. A desired resulting beamwidth β′ may be calculated in advance by simulation methods or “dialed in” on real time hardware by adjusting the amplitudes of the cancellation beamformer signals (weighting of cancellation beam output signals).

As discussed above, this invention is not continuously adaptive, as are prior art embodiments. A user of the system can “dial-in” or adjust the coefficients 22 and adjust the algorithm 24, or the algorithm 24 can adjust the coefficients 22. During a set-up process, the system can be, through trial and error, adjusted to an optimal state. As the characteristics of electronics can be particular to each component despite careful manufacturing, a small amount of adjustment is typically considered necessary for optimal operation. However, during operation, the set-up of the system 10 is quasi-static, obviating the need for continuous calculations, re-calculations, and calibrations during operation.

A desired beam can be steered to a desired direction, and then the process of the present invention can be utilized. In other words, one must know the direction of the desired signals to be received by the system and the regions that are to be subtracted. Having a knowledge that an acoustic signal is to originate from a particular direction, one selects a steering angle Θ for the main beam M and specifies the regions to be removed to narrow the beamwidth β to the beamwidth β′. It should be noted that it is not necessary to have a specific target or sound source in order to steer a beam. Beamforming is accomplished by phasing (delaying) the signals from the array elements such that the resulting beam(s) steers in various directions. The existence of desired signals, or a target, is not a precondition for steering and narrowing a beam.

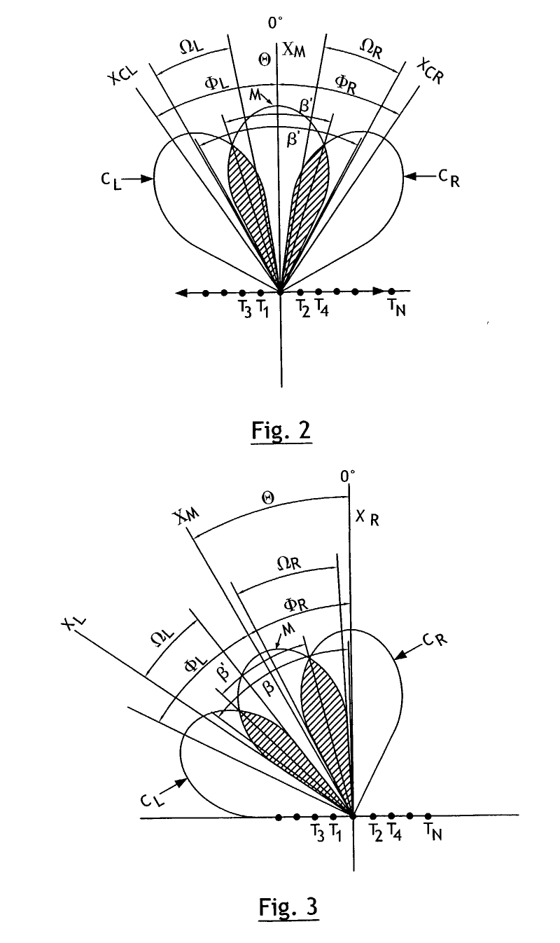

FIG. 3 represents, by way of example, the main beam M at a steering (or steered) angle Θ other than 0°, in this case and by way of example Θ=30°. FIG. 3 represents the instance where a known, desired acoustic source is located at 30° from the reference 0°.

The methodology represented in FIGS. 2 and 3 may be proved using Fourier analysis, including Fourier transform pairs, Fast Fourier transforms, or discrete, continuous, or fast (fast discrete) Fourier analysis. For instance, using two-dimensional Fourier transforms, the main beam M has a beamwidth β, while a desired beamwidth is β′. The method uses spatial representations of signals to determine the required spatial filter for beamwidth β in order to produce beamwidth β′. The spatial representation, or spatial signal of β, is denoted as the function a(x, y). The spatial representation of β′ is a′(x, y). Next, one denotes the function A(kₓ, k_{y}) as the 2-D Fast Fourier Transform (FFT) or wavenumber transform of a(x, y) while A′(kₓ, k_{y}) is the wavenumber transform of the desired beampattern. As a direct analogy to 1-D signal processing, there is a two dimensional (spatial) filter represented by the 2-D Fourier transform pair H(kₓ, k_{y}), h(kₓ, k_{y}) where H(kₓ, k_{y})=A′(kₓ, k_{y}) A(kₓ, k_{y}) in the wavenumber domain. The resulting required filter is the spatial representation denoted as the function h(x, y). The function h(x, y) is an inverse field representation and as such is referred to as a spatial filter for simplicity despite not operating as a filter is commonly known. A filter as is commonly known rejects the passing of certain portions of a one dimensional (time domain) signal.

In simpler terms, the use of Fourier Transforms relies on some basic principles. In the case of a time domain signal, it is known that an input signal I_{E} (not shown) can be used to produce a desired output signal array O_{E} (not shown) with particular characteristics, in this case beamwidth, by applying an electronic filter F_{E} (not shown). In the present system, the input signal I_{E} is known and the desired output O_{E} is known. Represented mathematically in the Time Domain, I_{E}(t)* F_{E}(t)=O_{E}(t), where * represents the operator known as convolution. When the input signal I_{E} and desired output O_{E} are transformed, the equation represents the Frequency Domain, and reads as I_{E}(ω)×F_{E}(ω)=O_{E}(ω) where × represents the operator known as multiplication. This equation can then simply solved as F_{E}(ω)=O_{E}(ω)/I_{E}(ω), again, F_{E}(ω) representing the filter in the Frequency Domain. Once the Frequency Domain filter has been determined, a reverse Fourier Transform on the filter produces the filter in the time domain. For two dimensional (or spatial) signals, the signal is a function of distance in x and y dimensions, I_{E}(x,y), and its transform is a function of wavenumber I_{E}(kₓ,k_{y}), for k=(2*pi*f)/c, where f is frequency and c is the propagation speed of the medium. This process is then implemented in the system 10.

It should be recognized that, in the preferred embodiment, all processing and steering as discussed herein is done in the time domain, with fixed steering angles and fixed delay. Accordingly, in the preferred embodiment, Fourier analysis is used as a design tool and for proving the concept. However, the scope of this application includes applications using the frequency domain as well. In the frequency domain, Fourier analysis may be employed not only as a design tool and for proving the concept, but also as a production tool. Fourier analysis in the wavenumber domain requires a significant amount of computing power, and accordingly may not always be feasible considering overall system parameters. In the preferred embodiment, Fourier analysis, such as the 2D FFTs, is not performed by components of the system or any computer code. These calculations (the aforementioned “dialing in”) are computed outside of the system 10, not only because of the potentially limited computing power but also because they involve computing the expected acoustic pickup pattern of the actual beamformer and a desired beamformer. The use of a 2D FFT may be applied as an outside design tool to precalculate/simulate expected beam patterns and determine proper cancellation beam steering and amplitude. For a time domain beamformer, fixed sampling rates result in fixed delays used for beamsteering, and therefore fixed steering angles. Accordingly, one can only predict beamwidths, angles, and overlap. Precise steering of the beams requires frequency domain beamforming. The method chosen is based on the type of beamformer used (i.e., discrete delays or magnitude/phase filters).

In the time domain, the method is simply steering cancellation beams to the left and/or right of the main beam such that there is some overlap. At that point the amplitudes of the cancellation beams may be adjusted until satisfactory results are achieved. This is typically the method one would choose when using discrete (fixed) delays for steering the beam (as in a digital, time-delay system), because the fixed delays dictate that steered beams can only occur at a limited number of fixed angles (for example, 20 degrees, 35 degrees, and 60 degrees). Precise steering of the beams requires frequency domain beamforming. The use of a Fourier analysis validates the theoretical basis of the method. In the frequency domain, the method is applied to beams formed by discrete time delays, or frequency domain filters on a channel-by-channel basis. The second method comes from the above Fourier analysis. Since the two dimensional Fourier transform can be used to validate the time delay method amplitude “dialing in” of the cancellation beams, it may also be used to determine the steering angle of cancellation beams required. In the case where filters are used to steer the beamformers—rather than fixed time delays—precise phase delays can form cancellation beams that can be steered to almost any angle. Therefore the 2D FFT provides the angle, amplitude, and expected outcome in advance.

Regardless of beamforming method used, the beamwidth will vary for steered beams as the array aperture changes with the cosine of the steering angle. For the case of a time delay beamformer, in the time domain, there a limited number of steering angles. Provided the beam patterns overlap, the amplitude coefficients of the undesired beams may be “dialed-in,” or “tuned,” to achieve satisfactory results. Therefore, one need not predetermine the beamwidths or precise steering angles, instead tuning the system to an empirically determined setting.

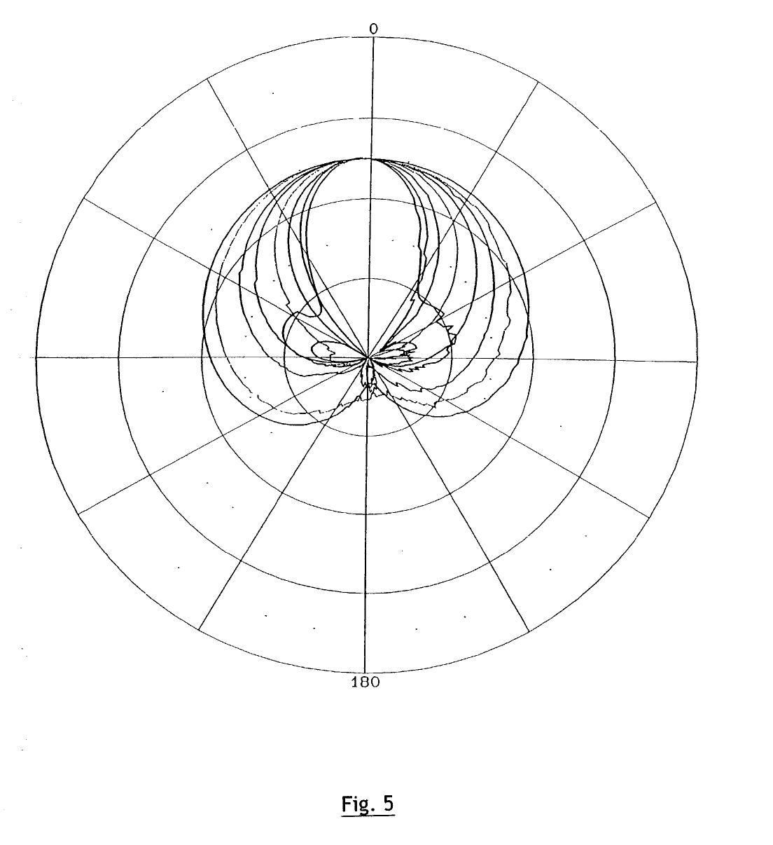

Under either method, the process of validation used spatial (2D) Fourier transforms as a verification of experimental method and data. For instance, in a manner similar to solving for an inverse transfer function in the time domain, the spatial domain filter shows lobes pointed to approximately +/−30 degrees as shown in FIGS. 5-8.

Given that the theoretical calculations verify and/or complement the experimental data, it is possible to use numerical representations of the actual and desired beampatterns to solve for the magnitude and phase of a spatial filter, which will indicate the direction that cancellation beams should be steered to achieve the desired beampattern. This may be considered as part of the design process, particularly for frequency domain beamformers, but it is not necessarily part of the processing algorithm used on a “realtime” basis in the system 10. This process of wavenumber processing with frequency domain beamforming could also be used with a feedback mechanism to control, or automatically “dial-in,” beam width adjustments. However, this requires processing power of a significant amount and is often not practical commercially.

In both time domain and frequency domain beamformers, a beam can be chosen, but not an angle. In the practice of time domain beamformers with time domain phase delays, it is not possible to precisely steer a beam. When a sound source is present in a beam, that beam is used. Because the sampling rate is fixed, the delays are a function of the sampling period. This results in a number of fixed beams. In this case, it is simplest to adjust attenuation coefficients of the plurality of beams, which are steered to said fixed angles to the left or right of the desired beam(s). Two-dimensional processing, such as discussed above, to set the coefficient values may be used, but is usually a formality.

In the case of frequency domain beamformers, where beam steering is a function of the phase imparted to each signal, the use of two dimensional Fourier transforms would be necessary in order to determine both amplitude coefficients and steering angles of the cancellation beams. In addition, a target beam may be identified, and a steering angle may selected by adjusting the phase of the signal on each element using the describe Fourier transform filtering processes.

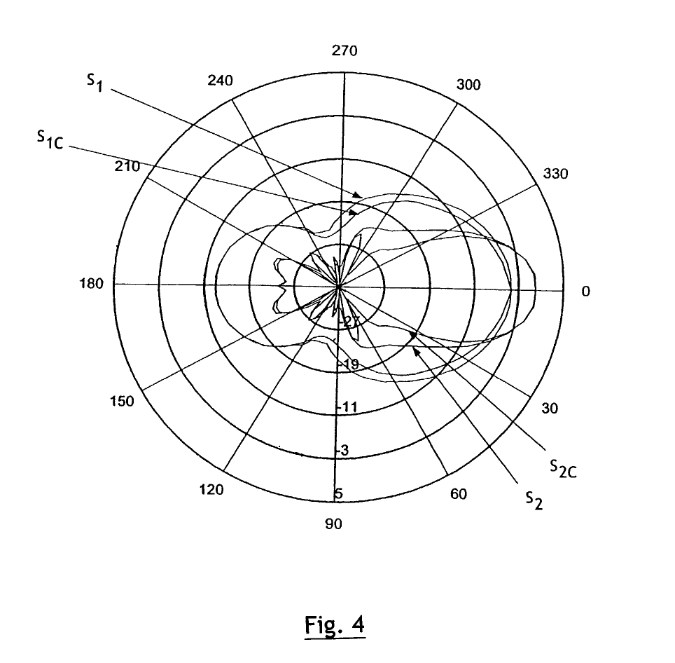

FIG. 4 depicts a polar plot of two beampatterns S₁ and S₂ (signal sensitivity vs. angle). Beampattern S₁ is a 1 kHz beampattern without cross-talk cancellation, while S_{1C} denotes the same beampattern S₁ with cross-talk cancellation. Beampattern S₂ is a 3 kHz beampattern without cross-talk cancellation, while S_{2C} denotes the same beampattern S₂ with cross-talk cancellation. As can be seen in FIG. 4, the plot of each beampattern S₁ and S₂ has been narrowed. Because of the processing, there is a reduction of sensitivity to beampattern reception at off-axis angles, reducing stray or undesirable signals (herein referred to as noise). This enhances the output by attenuating said off-axis signals.

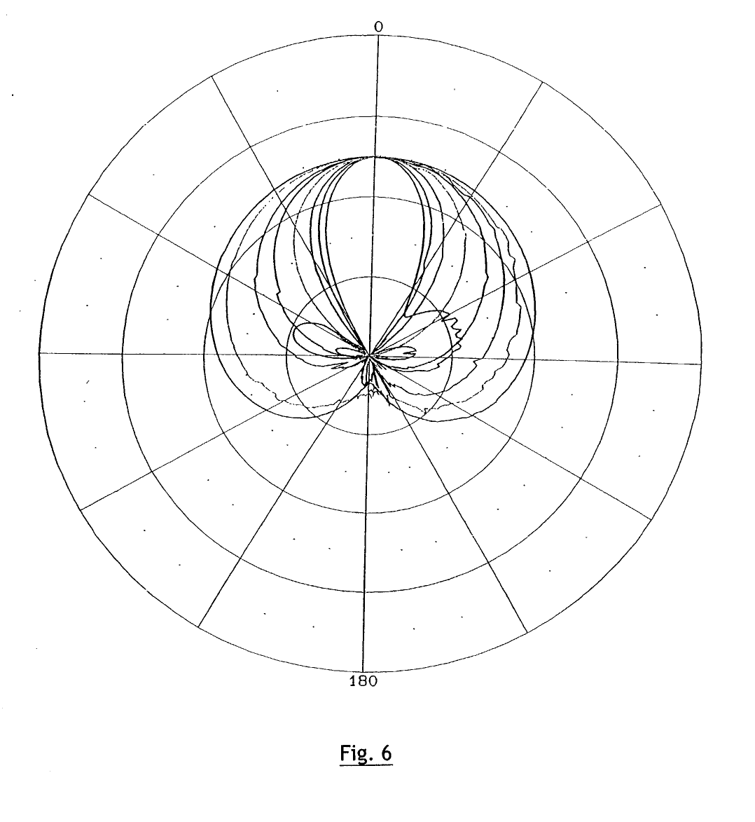

FIGS. 5-8 represent polar plotted data for a variety of frequencies, both with and without cross-talk cancellation, tested in an anechoic chamber, each major division of the plot representing 10 decibels. FIG. 5 depicts signals without cross-talk cancellation at frequencies of 400, 600, 800, 1000, 1200, 1600, 2000, 2400 Hz. FIG. 6 depicts the identical signals of FIG. 5 with cross-talk cancellation. Labeling each line as a particular frequency does not contribute to the understanding of the results of cross-talk cancellation. Accordingly, what should be noted about comparing FIG. 5 with FIG. 6 is that the lobed beams towards the center of the plot in FIG. 5 correspond to the same in the center of the plot in FIG. 6. In the lobed beams of FIG. 6, the spatial representations of the lobes are more defined and narrower. Similarly, the sidelobes (off-axis pickup lobes) of FIG. 5 have become smaller (narrower) in FIG. 6.

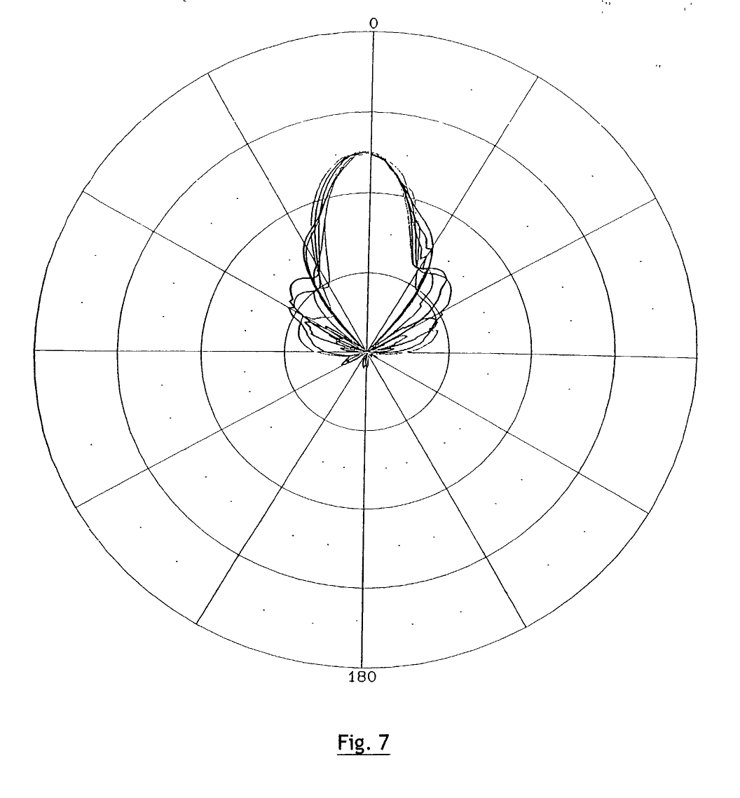

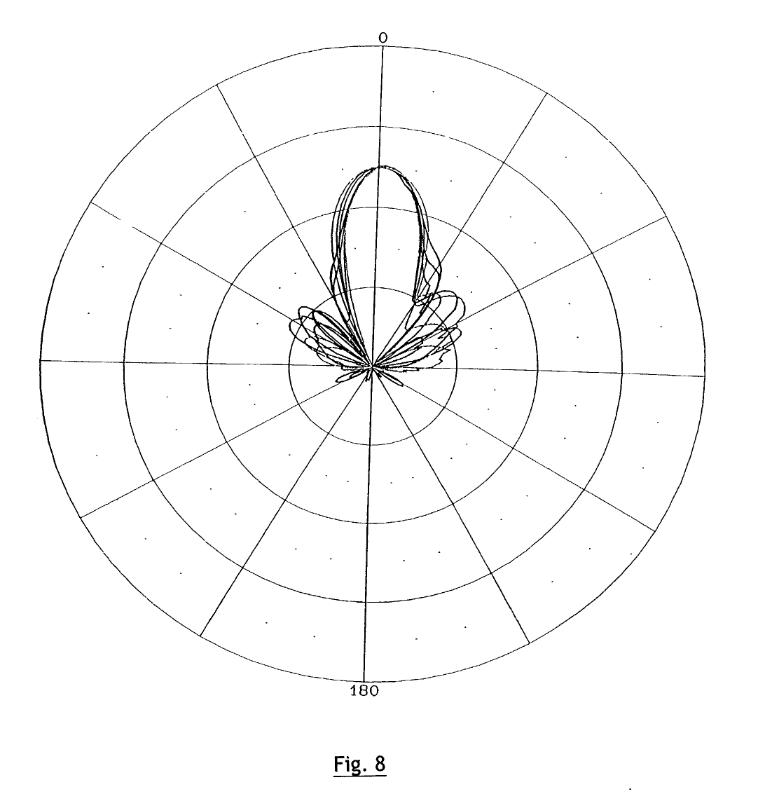

FIGS. 7 and 8 represent signals with frequencies of 2500, 2800, 3200, 3600, 4000, 4400, and 4700, without and with cross-talk cancellation, respectively. Similar to FIGS. 5 and 6, FIGS. 7 and 8 illustrate a narrowing and greater definition of the beam by utilizing cross-talk cancellation in accordance with the techniques of the present invention.

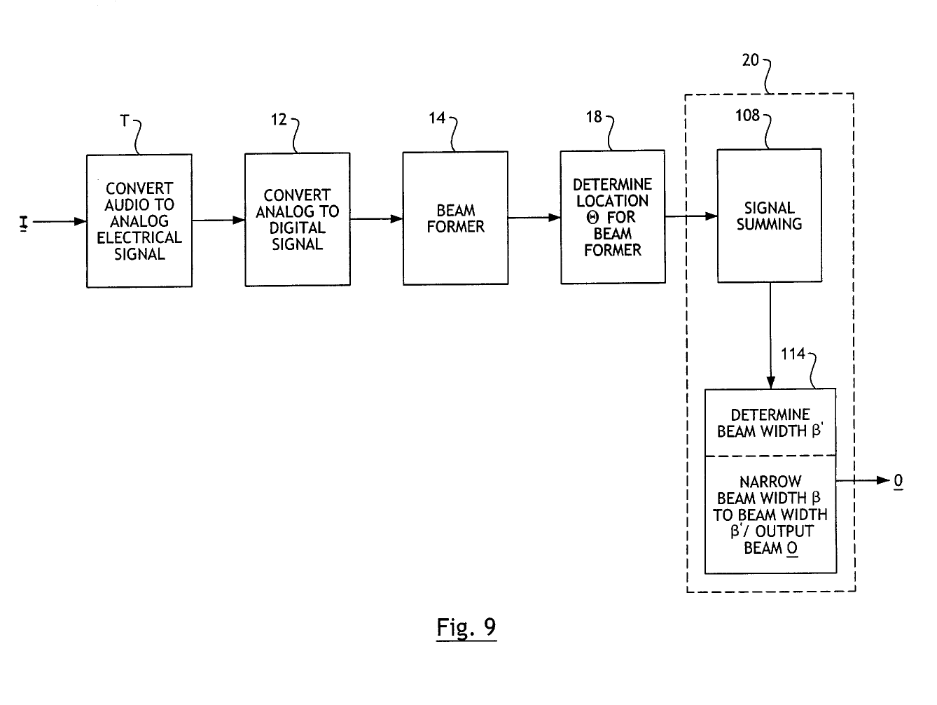

FIG. 9 provides a flow chart of the method of the present invention. Input signal I is received by a transducer T which converts the acoustic audio signal into an analog electrical signal. An A/D converter 12 converts the analog electrical signal to a digital signal D. As represented in the present embodiment, the digital signal D is sent to the beamformer 14 and becomes an output beam 16. Block 18 provides the location or determines the location Θ (see FIGS. 2, 3) for beam M. Blocks 14 and 18 produce a direction dependent signal sensitivity that can be represented in a graphical form as beams for a polar plot. The signals, now viewed as beams, are passed to block 108 where the signals, if multiple signals are present, are summed. The summed beams are then sent to the block 20 represented as dashed lines.

In further embodiments of present invention, it should be noted that any analog method for forming beams and applying non-adaptive cancellation using 2D FFT, other FFTs, or experimental (empirical) adjustment or tuning of the device may be used. Additionally, it should be noted that, as a single microphone or transducer assembly can be used for multiple sound paths, and hence multiple acoustic signals (i.e. process signals from multiple simultaneous directional pickup patterns), a single microphone or transducer assembly may be implemented in the present application. An acoustic beamformer with multiple ports that can be used for forming independent beams may be utilized in the same manner as described herein. For example, the invention of U.S. Pat. No. 5,862,240 to Okhubo, et al., may be utilized as a single microphone or transducer element, and multiple tubes of various lengths in conjunction with insulation may be used to attenuate sound and create a phase shift in sound in multiple tubes. These methods and systems may then be used to form independent beams as is necessary for the present invention.

The method and system of the present application may further use components that generally function with a similar result as a microphone. The method is equally applicable to arrays of similar transducers such as hydrophones and geophones.

Though Fourier analysis is a principle means discussed in this application, it is clear that a number of mathematical computations could be supplemented for performing the mathematics, and the present methods are to be in no way limited to use of Fourier analysis. Such should be particularly clear as Fourier analysis may entirely be supplanted by empirical methods.

It should be noted that the steps in this invention need not be performed exactly as described. For instance, some of these steps may be performed by dedicated hardware, or circuitry, or by software applications, or by some combination of hardware, circuitry, and software. Accordingly, it is clear that the components of the system of the present invention may also be a one or a combination of hardware, circuitry, and software. For this reason, it is also clear that the invention is not necessarily dependent on the order or the location of steps or system components.

As various changes could be made in the above constructions without departing from the scope of the invention, it is intended that all matter contained in the above description or shown in the accompanying drawings shall be interpreted as illustrative and not in a limiting sense.

1. A system for improving an output of a transducer signal comprising:
at least one transducer;
a beamformer;
at least one chosen, fixed input beam;
an algorithmic block producing a desired resulting output beam having a narrowed on-axis beamwidth; and
an output signal comprising the desired resulting output beam having a narrowed beamwidth.

2. The system of claim 1 further comprising multiple chosen, fixed input beams, wherein the algorithmic block produces a plurality of desired output beams, and wherein the output signal comprises a plurality of desired output beams having a desired beamwidth.

3. The system of claim 1 wherein the transducer is a microphone which simultaneously receives multiple, acoustic signals which can be spatially represented as beampatterns.

4. The system of claim 3 wherein the system includes a plurality of transducers.

5. The system of claim 4 wherein the transducer is selected from among the group of a microphones, reciprocal transducers, hydrophones, or geophones.

6. The system of claim 1 wherein the narrowed on-axis beamwidth of a desired resulting beam is produced by superpositioning a desired main beam with a beam steered at an angle from the axis of the desired main beam.

7. The system of claim 1 wherein the algorithmic block produces narrowed on-axis beamwidths for multiple desired main beams, and wherein the algorithmic block sums the beamformer outputs for the multiple desired resulting beams, and wherein the output signal comprises the beamformer outputs for the multiple desired resulting narrowed beams.

8. The system of claim 1 further comprising a microprocessor, and wherein the microprocessor includes the algorithmic block.

9. The system of claim 1 wherein the algorithmic block comprises:
computer executable instructions; and
a medium for having stored therein the computer executable instructions.

10. The system of claim 1 further including multiple sound paths to the transducer, wherein the multiple sound paths create multiple signals corresponding to the multiple sound paths, and wherein the multiple sound paths create a phase shift in the multiple signals.

11. The system of claim 10 wherein the multiple sound paths have varying resonators for attenuation and creating the phase shift.

12. The system of claim 10 wherein the multiple sound paths have differing lengths and include insulation for attenuation and creating the phase shift.

13. The system of claim 10 wherein the multiple sound paths have varying cross-sections for attenuation and creating the phase shift.

14. A method for narrowing the desired pickup of a desired signal comprising the steps of:
determining a location on a spatial representation of a desired main beam containing the desired signal; and
and narrowing the width of the desired beam of the desired signal.

15. The method of claim 14 wherein the step of determining a location is empirically performed and is fixed.

16. The method of claim 14 wherein the step of determining a location is performed using mathematical analysis.

17. The method of claim 16 wherein the mathematical analysis is multidimensional Fourier transforms.

18. The method of claim 14 wherein the desired signal is an analog acoustic signal, and wherein the method further includes the steps of:
receiving an input signal by a transducer;
forming beams from said input signal; and
outputting an output signal.

19. The method of claim 14 wherein the step of narrowing the width of the desired beam includes:
producing a cancellation beam;
steering the central axis of the cancellation beam with or by phase shifts specified by the desired resulting beamwidth of the narrowed desired beam; and
subtracting the cancellation beam from the desired main beam via superpositioning.

20. The method of claim 19 wherein said narrowing the beamwidth includes:
producing a second cancellation beam;
steering the central axis of the second cancellation beam to a second angle specified by the desired resulting beamwidth of the desired resulting beam; and
subtracting the second cancellation beam from the desired main beam via superpositioning.

21. The method of claim 14 wherein the method is simultaneously performed on multiple desired main beams to produce multiple improved on-axis signal pickups.

22. The method of claim 21 wherein the method further includes the step of summing the narrowed multiple desired main beams.

23. The method of claim 14 wherein the step of narrowing the beamwidth is performed by a microprocessor.

24. The method of claim 23 wherein the microprocessor includes computer executable instructions and a medium for reading said executable steps.

25. A non-continuously adaptive method for improving the on-axis pickup of a desired input signal comprising the steps of:
determining location on a spatial representation of a desired main beam of the desired input signal;
determining a desired resulting beamwidth of a desired resulting beam;
narrowing the beamwidth of the desired main beam by removing an area of the spatial representation of the desired main beam;
producing a desired resulting output beam; and
producing an output signal from the desired resulting output beam.

26. The method of claim 25 wherein the step of determining a desired resulting beamwidth is empirically performed.

27. The method of claim 25 wherein the step of determining a desired resulting beamwidth is mathematically performed.

28. The method of claim 25 wherein the step of determining a desired resulting beamwidth is performed using Fourier transforms.

29. The method of claim 25 wherein said step of narrowing the beamwidth includes:
producing a cancellation beam; and
steering the central axis of the cancellation beam a phase specified by the pre-determined desired resulting beamwidth of the desired resulting output beam; and subtracting the cancellation beam from the desired main beam via superpositioning.

30. The method of claim 29 wherein the step of narrowing the beamwidth includes:
producing multiple cancellation beams wherein each cancellation beam overlaps the desired main beam;
steering the central axis of the multiple cancellation beams a phase specified by the desired resulting beamwidth of the desired resulting output beam;
and subtracting the multiple cancellation beams from the desired main beam via superpositioning.

31. The method of claim 30 wherein the method simultaneously improves multiple, desired main beams and simultaneously produces multiple desired resulting output beams.

32. The method of claim 31 wherein the output signal comprises each of the multiple resulting desired output beams.

33. The method of claim 32 wherein the multiple desired resulting output beams are produced from multiple desired input signals.

34. The method of claim 29 wherein the method further includes the steps of:
receiving said desired input signal by a transducer;
forming beams from said desired input signal prior to said producing a cancellation beam; and
outputting said output signal.

35. The method of claim 34 wherein the method further includes the step of converting said desired input signal from an analog signal to a digital signal.

36. The method of claim 25 wherein the step of narrowing the beamwidth is performed by a microprocessor.

37. The method of claim 36 wherein the microprocessor includes computer executable instructions and a medium for reading said executable steps.

38. A computer-readable medium having computer-executable instructions for performing steps comprising:
locating a spatial representation of a desired main beam of a desired input signal;
producing a cancellation beam;
steering the central axis of the cancellation beam a phase specified by the desired resulting beamwidth of the narrowed desired beam; and
subtracting the cancellation beam from the desired main beam via superpositioning.

39. The computer readable medium of claim 38 having further computer-executable instructions for performing the steps of:
producing multiple cancellation beams;
steering the central axis of the multiple cancellation beams a phase specified by the desired resulting beamwidth of the desired resulting beam; and
subtracting the multiple cancellation beams from the desired main beam via superpositioning.

40. The computer readable medium of claim 38 having further computer-executable instructions for performing the steps of:
receiving said signal by a transducer;
converting said signal from an analog signal to a digital signal;
forming beams from said signal; and
outputting said signal.
